(19) United States
(12) Patent Application Publication
(10) Pub. No.: US 2008/0307042 A1
(43) Pub. Date: Dec. 11, 2008

(54) Information processing system, information processing method, and program

(75) Inventors: Takashi Honda, Yokohama (JP); Toshimichi Sasage, Ichikawa (JP); Masahiko Inoki, Kawasaki (JP)

Correspondence Address: FOLEY AND LARDNER LLP;SUITE 500, 3000 K STREET NW, WASHINGTON, DC, 20007, US

(73) Assignee: Hitachi, Ltd

(21) Appl. No.: 12/004,493

(22) Filed: Dec. 21, 2007

(30) Foreign Application Priority Data
Jun. 8, 2007 (JP) 2007-153150

(51) Int. Cl. G06F 15/16; G06F 1/32

(52) U.S. Cl. 709/203; 713/320

(57) ABSTRACT

A system comprising: a server for receiving operation information from a client, performing an information process in accordance with the received operation information, and transmitting the result of the information process; and a managing device. The managing device monitors whether communication is performed between the client and the server and transmits an operation mode switching request to the server so as to switch the server operation mode to a power saving mode requiring less power consumption than the current operation mode if no communication is performed. The server receives the operation mode switching request transmitted from the managing device and switches the server operation mode to the power saving mode in accordance with the operation mode switching request.

### INCORPORATION BY REFERENCE

The present application claims priority from Japanese application JP 2007-153150 filed on Jun. 8, 2007, the content of which is hereby incorporated by reference into this application.

### BACKGROUND OF THE INVENTION

The present invention relates to an information processing system, an information processing method, and a program.

Recently, an information processing system of the thin client configuration using a client having only the minimum function such as data input and output. In the information processing system of the thin client configuration, one or more servers are made to be in a waiting state all the time, so that upon reception of a use request made by a client, some or all the resources of the waiting servers are exclusively dedicated to the client and after completion of the use by the client, the servers used by the client are returned to the waiting state. JP-A-2003-203189 discloses a rental system of a server whose power is turned ON when it is used by a client and turned OFF when use by the client is completed.

When a client completes use of a server, the client should send an end instruction to the server.

However, when the client power is turned OFF before transmission of the end report to the server or when a failure has occurred in the client, or a failure has occurred in the communication network, the end instruction from the client to the server may not be sent. In this case, in spite of that the communication between the server and the client is disconnected, the information processing of the server is continued and power is consumed in vain.

### SUMMARY OF THE INVENTION

It is therefore an object of the present invention to provide an information processing system, an information processing method, and a program capable of suppressing useless power consumption by a server.

In order to achieve the aforementioned object, the present invention provides an information processing system comprising: a server which receives operation information from a client receiving an operation from a user, executes information processing in accordance with the received operation information, and transmits the information processing result to the client; and a managing device connected to the client and the server. The managing device includes: a client monitor unit which monitors whether communication is performed between the client and the server; and an operation mode switching request transmission unit used when no communication is performed, for transmitting an operation mode switching request to the server so as to instruct it to switch from the current operation mode to a power saving mode consuming less power. The server includes: an operation switching request reception unit which receives the operation mode switching request transmitted from the managing device; and an operation mode switching unit for switching the saver operation mode to the power saving mode in accordance with the operation mode switching request.

The present invention can suppress useless power consumption of the server.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing the entire configuration of an information processing system according to an embodiment of the present invention.

FIG. 2 is a block diagram showing a software configuration of the information processing system according to the present embodiment.

FIG. 3 shows a configuration example of an allocation managing table of a managing server in the present embodiment.

FIG. 4 is a table showing an example of operation states of a blade server.

FIG. 5 is a table showing a configuration example of an operation mode managing table of the managing server in the present embodiment.

FIG. 6 is a flowchart of processes performed by a client in the present embodiment.

FIG. 7 is a flowchart of processes performed by the managing server in the present embodiment.

FIG. 8 is a flowchart of processes performed by the blade server in the present embodiment.

FIG. 9 is a flowchart of processes performed by the managing server when transmitting a ping command in response to the operation state.

FIG. 10 is a block diagram showing a software configuration of the information processing system when the blade server monitors a client.

FIG. 11 is a flowchart of processes performed by the blade server when the blade server monitors a client.

### DESCRIPTION OF THE INVENTION

Description will now directed to an information processing system according to an embodiment of the present invention with reference to the attached drawings.

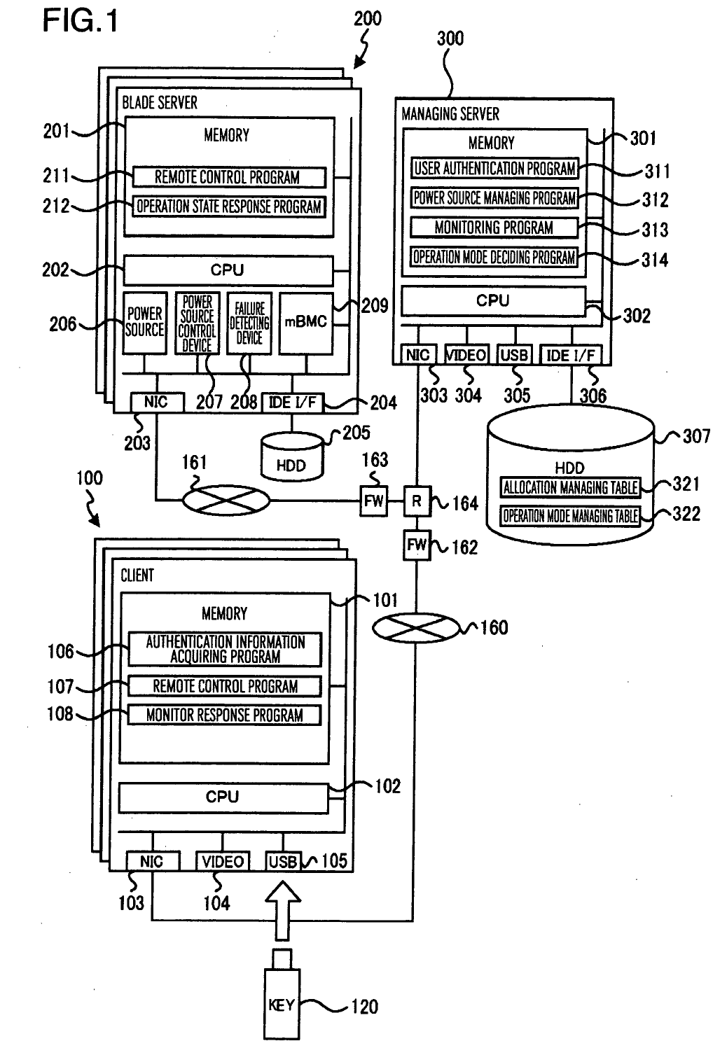

FIG. 1 is a block diagram showing the entire configuration of the information processing system according to the embodiment of the present invention. An information processing system according to the present embodiment includes a client 100, a blade server 200, and a managing server 300.

The information processing system of the present embodiment has the so-called thin client configuration. Various types of information processes are performed in the blade server 200. The client 100 only executes the process of receiving input data (operation information) from a keyboard and a mouse, transmitting it to the blade server 200, and receiving results of the information processing. Moreover, in response to a request from the client 100, the information processing system of the present embodiment allocates the blade server 200 to be used by the client 100.

The information processing system of the present embodiment sets the operation mode of the blade server 200 in accordance with the operation state of the client 100 and the blade server 200.

In this embodiment, the operation mode of the blade server 200 may be in one of the following modes: an ON mode which is an operation mode when normal information processing is performed; a standby mode which is an operation mode when power is supplied to a memory but no power is supplied to peripheral devices such as a CPU and a hard disk so as to reduce power consumption; a break mode which is an operation mode for saving data stored in the memory into a storage device such as a hard disk and loading the data saved in the storage device into the memory upon the next operation of the blade server 200 so as to resume the operation from the moment when the data has been saved; and an OFF mode which is an operation mode for turning power supply OFF, operating only an mBMC circuit for performing power supply management which will be detailed later and performing blade processing of the blade server 200 upon the next start of the blade server 200. That is, as compared to the case when the blade server 200 is in the ON mode, the power consumption of the blade server 200 is significantly reduced when it is in the standby mode, the break mode, or the OFF mode. It should be noted that in the explanation given below, the ON mode, the standby mode, the break mode, and the OFF mode may also be expressed as “ON, “standby”, “break”, and “OFF”, respectively.

The power control technique for setting the aforementioned operation modes is known, for example, as ACPI (Advanced Configuration and Power Interface) and IPMI (Intelligent Platform Management Interface).

The client 100 is connected to the network 160. The blade server 200 is connected to the network 161. The network 160 and the network 161 may be, for example, LAN (Local Area Network) built by the Ethernet (registered trademark) and a public telephone line network and the Internet, which may be cabled or cable-less.

The network 160 is connected to a router 164 via a firewall 162. The network 161 is connected to the router 164 via a firewall 163. The managing server 300 is directly connected to the router 164. Accordingly, the client 100, the managing server 300, and the blade server 200 can perform bi-directional communication between themselves. It should be noted that this embodiment assumes that the client 100, the managing server 300, and the blade server 200 perform communication by TCP/IP.

The client 100 has a memory 101, a CPU 102, an NIC 103, a video interface 104, and a USB (Universal Serial Bus) interface 105.

The video interface 104 is connected to a display device such as a liquid crystal display. The client 100 outputs screen information on the display device via the video interface 104.

The USB interface 105 is connected to an input device such as a keyboard and a mouse. The client 100 receives data (hereinafter, referred to as operation information) inputted by a user via the USB interface 105.

Moreover, the USB interface 105 is connected to an individual authentication device 120. The individual authentication device 120 stores authentication information such as a password and an electronic certificate. For example, it is a storage device such as a flash memory, an IC card, and a hard disk drive. In this embodiment, it is assumed that a user identifier (hereinafter, referred to as a user ID) is stored as the authentication information in the individual authentication device 120. It should be noted that as the authentication information, it is possible to use, for example, a combination of a user ID and a password or an electronic certificate stipulated in X.509 recommended by ITU-T (International Telecommunication Union Telecommunication Standardization Sector).

The memory 101 contains an authentication information acquisition program 106, a remote control program 107, and a monitor response program 108.

The CPU 102 realizes various functions by executing the programs stored in the memory 101.

It should be noted that in FIG. 1, the client 100 does not include an HDD (Hard Disk Drive) but it may also have an HDD.

The managing server 300 includes a memory 301, a CPU 302, an NIC 303, a video interface 304, a USB interface 305, an IDE (Integrated Drive Electronics) interface 306 for making a connection with the HDD, and an HDD 307 connected to the IDE interface 306.

The video interface 304 is connected to a display device. The managing server 300 outputs screen information to the display device via the video interface 304.

The USB interface 305 is an interface for connecting peripheral devices and is connected to input devices such as a mouse and a keyboard. The managing server 300 receives operation information from the mouse and the keyboard via the USB interface 305.

The HDD 307 contains an allocation managing table 321 and an operation mode managing table 322. These tables will be detailed later. The HDD 307 may be built in the managing server 300 or installed outside. Moreover, the HDD 307 may be a NAS (Network Attached Storage) accessed via the network.

The memory 301 contains a user authentication program 311, a power managing program 312, a monitor program 313, and an operation mode decision program 314.

The CPU 302 realizes various functions by executing various programs stored in the memory 301.

The blade server 200 includes a memory 201, a CPU 202, a NIC 203, an IDE interface 204, an HDD 205, a power source 206, a power source control device 207, a failure detection device 208, mBMC (mini-Baseboard Management Controller) 209.

The HDD 205 is a storage device for storing various programs of, for example, an operating system and data. The programs stored in the HDD 205 are read into the memory 201 and executed. The HDD 205 may be built in the blade server 200 or installed outside. Moreover, the HDD 205 may be a NAS accessed via the network.

The memory 201 stores a remote control program 211 and an operation state response program 212.

The CPU 202 realizes various functions by executing the programs stored in the memory 201.

The power source 206 supplies power supplied from outside to the blade server 200. The power control device 207 has a function to control the power source 206.

The failure detection device 208 monitors signals of a temperature sensor and a voltage sensor (not depicted) installed in the blade server 200, judges whether a signal satisfies a predetermined condition to detect a failure, and response the failure presence/absence in response to an inquiry from outside.

The mBMC 209 is identical to the BMC stipulated in the IPMI from which some functions are omitted. In response to a command received from outside, the mBMC 209 turns ON and OFF the power source 206 of the blade server 200 and shifts it to a power saving mode, thereby controlling the power source 206. It should be noted that the BMC (Baseboard Management Controller) as a component stipulated in the IPMI used for remote power control is introduced, for example, in “-IPMI-Intelligent Platform Management Interface Specification Second Generation v2.0 Document Revision 1.0”, page 29.

The NIC 203 is an interface for making a connection to the network 161 such as an adapter for connection to the Ethernet (registered trademark) and a modem for connection to a telephone line network.

It should be noted that power is supplied to the NIC 203, the mBMC 209, and the power control device 207 from an auxiliary power source (not depicted) which is different from the power source 206. Accordingly, even if the power source 206 is in the OFF state, they can receive a command and can control the power source 206.

The network 160 is connected to the NIC 103 of the client 100 and the network 161 is connected to the NIC 203 of the blade server 200.

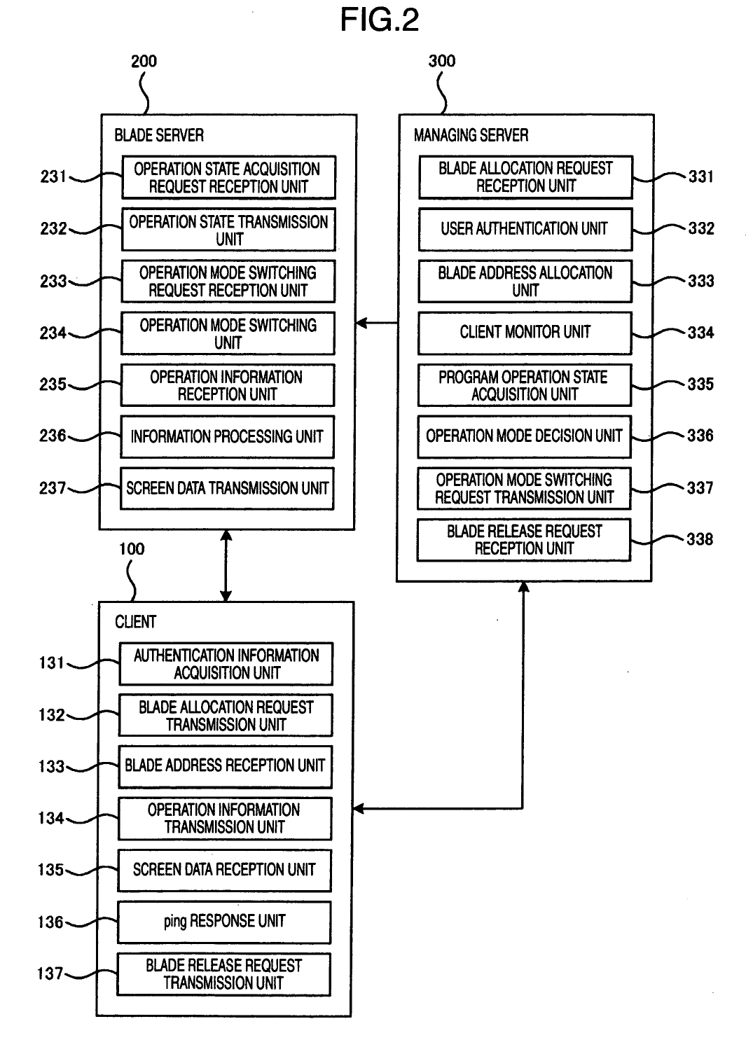

FIG. 2 shows a software configuration of the information processing system according to the present embodiment.

The client 100 includes an authentication information acquisition unit 131, a blade allocation request transmission unit 132, a blade address reception unit 133, an operation information transmission unit 134, a screen data reception unit 135, a ping response unit 136, and a blade release request transmission unit 137.

The authentication information acquisition unit 131 reads out a user ID stored in the individual authentication device 120.

The blade allocation request transmission unit 132 transmits a command for starting the use of the blade server 200 (hereinafter, referred to as a blade allocation request) to the managing server 300. In the blade allocation request, the user ID read from the individual authentication device 120 is set. The blade allocation request transmission unit 132 is realized by the CPU 102 which executes the authentication information acquisition program 106 stored in the memory 101.

The blade address reception unit 133 receives an IP address of the blade server 200 (hereinafter, referred to as a blade address) transmitted from the managing server 300 in response to the blade allocation request and stores the received blade address in the memory 101.

The operation information transmission unit 134 transmits the operation information received from the input device such as a keyboard and a mouse to the blade server 200 indicated by the blade address stored in the memory 101.

The screen data reception unit 135 receives data for displaying a screen indicating the result of the information processing performed in the blade server 200 in response to the operation information (hereinafter, referred to as screen data). Moreover, the screen data reception unit 135 outputs the received screen data to the display device connected to the video interface 104.

The aforementioned blade address reception unit 133, the operation information transmission unit 134, and the screen data reception unit 135 are realized when the CPU 102 executes the remote control program 107 stored in the memory 101.

The ping response unit 136 receives a command inquiring whether the client 100 is operating (hereinafter, referred to as an operation check command) transmitted from the managing server 300 which will be detailed later and transmits a response indicating that the client 100 is operating, to the managing server 300 in accordance with the received operation check command. In this embodiment, it is assumed that the ping command is used as the operation check command. The ping response unit 136 is realized when the CPU 102 executes the monitor response program 108 stored in the memory 101.

The blade release request transmission unit 137 transmits a command to instruct to terminate the use of the blade server 200 and release the allocation of the blade server 200 which has been allocated to the client 100 (hereinafter, referred to a blade release request), to the managing server 300. In the blade release request, a user ID is set. The blade release request transmission unit 137 transmits the blade release request to the managing server 300, for example, according to an instruction of log out from a user. The blade release request transmission unit 137 is realized when the CPU 102 executes the authentication information acquisition program 106 stored in the memory 101.

It should be noted that in this embodiment, the respective functions of the client 100 are realized when the CPU 102 executes various programs stored in the memory 101. However, the respective functions may also be realized as hardware such as circuits.

The managing server 300 includes a blade allocation request reception unit 331, a user authentication unit 332, a blade address allocation unit 333, a client monitor unit 334, a program operation state acquisition unit 335, an operation mode decision unit 336, an operation mode switching request transmission unit 337, and a blade release request reception unit 338.

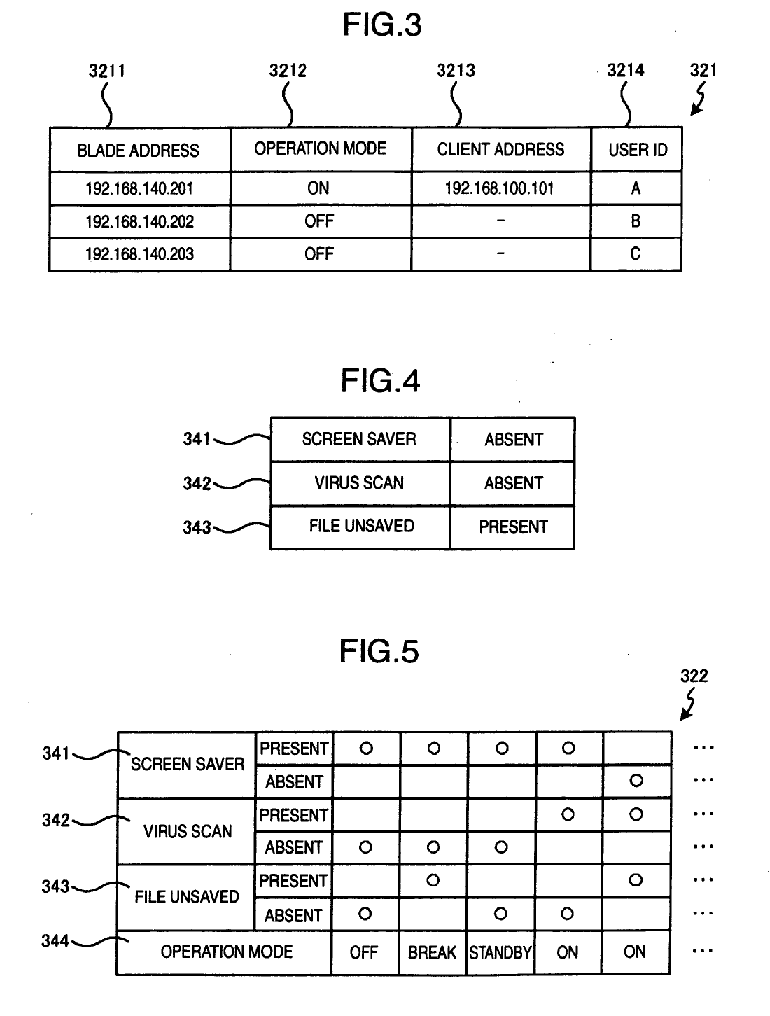

FIG. 3 is a table showing a configuration of the allocation managing table 321. As shown in the table, the allocation managing table 321 is formed by a blade address 3211, an operation mode 3212, a client address 3213, and a user ID 3214.

The blade address 3211 is an IP address of the blade server 200 and is used for communication between the client 100 and the blade server 200. For the blade address, an IP address given for each NIC 203 of the blade server 200 is stored.

The operation mode 3212 is an operation mode of the blade server 200 and may be one of “ON”, “standby”, “break”, and “OFF” in this embodiment.

The client address 3213 is an IP address of the client 100 where the blade server 200 is allocated (hereinafter, referred to as a client address).

In the user ID 3214, a user ID which can use the blade server 200 indicated by the blade address 3211 is set. It should be noted that correspondence between the blade address 3211 and the user ID 3214 is preset by an administrator, for example.

The blade allocation request reception unit 331 receives the blade allocation request transmitted from the client 100.

The user authentication unit 332 performs user authentication by using the user ID set in the blade allocation request. It should be noted that for the user authentication process, for example, it is possible to use a general process such as a password correlation and an electronic certificate authentication process. However, in the present embodiment, the user authentication is performed by deciding whether the user ID set in the blade allocation request is registered in the allocation managing table 321.

In response to the blade allocation request received from the client 100, the blade address allocation unit 333 acquires the blade address 3211 corresponding to the user ID set in the blade allocation request from the allocation managing table 321. The blade address allocation unit 333 responds the acquired blade address 3211 to the client 100 and sets the IP address of the client 100 as the transmission source of the blade allocation request for the client address 3213 corresponding to the user ID.

The blade release request reception unit 338 receives the blade release request transmitted from the client 100.

In response to the blade release request, the blade address allocation unit 333 updates the client address 3213 corresponding to the user ID set in the blade release request to “-” and sets the operation mode 3212 corresponding to the user ID to “OFF”.

The client monitor unit 334 monitors whether no failure has occurred in the operation of the client 100. The client monitor unit 334 transmits the ping command to the client 100 and checks whether a response to the ping command is received from the client 100, thereby monitoring whether no failure has occurred in the operation of the client 100.

The program operation state acquisition unit 335 transmits a command for acquiring an operation state of the program in the blade server 200 (hereinafter, referred to as an operation state acquisition request) to the blade server 200 and receives the program operation state transmitted from the blade server 200 in response to the operation state acquisition request. FIG. 4 shows an example of the operation state transmitted from the blade server 200. As shown in this figure, in the present embodiment, the operation state transmitted from the blade server 200 is formed by information 341 indicating whether the screen saver is being executed (hereinafter, referred to as screen saver information), information 342 indicating whether a virus scan program is being executed (hereinafter, referred to as virus scan information), and information 343 (hereinafter, referred to as file unsaved information) indicating whether a process of opening a file being edited and not yet stored (hereinafter, referred to as a file unsaved process) is being executed.

The screen saver is a program which is executed when the blade server 200 received no operation information from the client 100 for a certain time. The screen saver information may be “present” indicating that the screen saver is being executed or “none” indicating that the screen saver is not being executed.

The virus scan program is an example of a program having a high access frequency to the HDD 205 in the blade server 200 and checks whether the blade server 200 contains any file infected with virus. Normally, a user does not operate a computer in which a virus scan program is being executed. The virus scan information may be “present” indicating that the virus scan program is being executed or “none” indicating that no virus scan program is being executed. The virus scan information may make a judgment, for example, by checking whether a predetermined virus scan program is executed and access to the HDD 205 is executed.

It is possible to judge whether a unsaved file is opened in a certain process, for example, by referencing an attribute of a file identifier managed in the process by an operating system which operates in the blade server 200 or by checking whether a dialog box for storing the file is displayed in the process. Alternatively, it is possible to make a judgment by reporting a signal to the process and checking whether the pop-up dialog box is displayed in response to the signal. It is also possible to preset a predetermined editor and a word processor program and report the signal only to the set program.

The operation mode decision unit 336 decides the operation mode of the blade server 200 in accordance with the operation state of the client 100 and the blade server 200. As will be detailed later, when an error exists in the operation of the client 100 (when no response is received to the ping command from the client 100, i.e., when no communication is performed between the client 100 and the blade server 200), the operation mode decision unit 336 decides the operation mode in accordance with the operation state of the program in the blade server 200.

The operation mode based on the operation state of the blade server 200 is managed by the operation mode managing table 322 stored in the HDD 307. FIG. 5 shows a configuration of the operation mode managing table 322. As shown in the figure, the operation mode managing table 322 stores the operation mode 344 correlated to the operation state of the blade server 200 (screen saver information 341, virus scan information 342, and file unsaved information 343). The operation mode 344 may be “ON”, “standby”, “break”, or “OFF”.

The operation mode decision unit 366 decides the operation mode of the blade server 200 by acquiring the operation mode 344 corresponding to the operation state received from the blade server 200, from the operation mode managing table 322.

Moreover, the operation mode decision unit 336 decides the ON mode as the operation mode upon reception of the blade allocation request and decides the OFF mode as the operation mode upon reception of the blade release request.

The operation mode switching request transmission unit 337 transmits a command for switching the operation mode of the blade server 200 (hereinafter, referred to as an operation mode switching request) to the blade server 200. In the operation mode switching request, the operation mode 344 read by the operation mode decision unit 336 is set.

It should be noted that in this embodiment, respective functions of the managing server 300 are realized when the CPU 202 of the managing server 300 executes various programs stored in the memory 201. The respective functions may also be realized as hardware such as circuits.

The blade server 200 includes: an operation state acquisition request reception unit 231; an operation state transmission unit 232, an operation mode switching request reception unit 233; an operation mode switching unit 234; an operation information reception unit 235; an information processing unit 236; and a screen data transmission unit 237.

The operation state acquisition request reception unit 231 receives an operation state acquisition request transmitted from the managing server 300.

In accordance with the operation state acquisition request, the operation state transmission unit 232, for example, inquires the operation system operating in the blade server 200 so as to check whether the screen saver is being executed and whether the virus scan program is being executed in the blade server 200. Moreover, for each of the processes operated in the blade server 200, the operation state transmission unit 232, for example, inquires the operating system or judges whether the pop-up dialog for file storage is displayed so as to check whether a file being edited and unsaved is opened. The operation state transmission unit 232 transmits the operation states containing the screen saver information, the virus scan information, and the file unsaved information to the managing server 300.

The operation state acquisition request reception unit 231 and the operation state transmission unit 232 are realized when the CPU 202 executes the operation state response program 212 stored in the memory 201.

The operation mode switching request reception unit 233 receives the operation mode switching request transmitted from the managing server 300. The operation mode switching unit 234 switches the operation mode of the blade server 200 to the operation mode specified in the operation mode switching request. The operation mode switching request reception unit 233 and the operation mode switching unit 234 are realized, for example, as the functions of the mBMC.

The operation information reception unit 235 receives the operation information transmitted from the client 100. The information processing unit 236 performs various information processes in accordance with the operation information received from the client 100. The screen data transmission unit 237 generates screen data for displaying the screen indicating the result of the information process performed by the information processing unit 236 and transmits the generated screen data to the client 100.

The operation information reception unit 235 and the screen data transmission unit 237 are realized when the CPU 202 executes the remote control program 211 stored in the memory 201. The information processing unit 236 is realized when the CPU 202 reads out the program stored in the HDD 205 to the memory 201 and executes it.

It should be noted that in this embodiment, the aforementioned respective function units are realized when the CPU 202 executes the programs stored in the memory 201. However, the respective function units may also be realized by hardware.

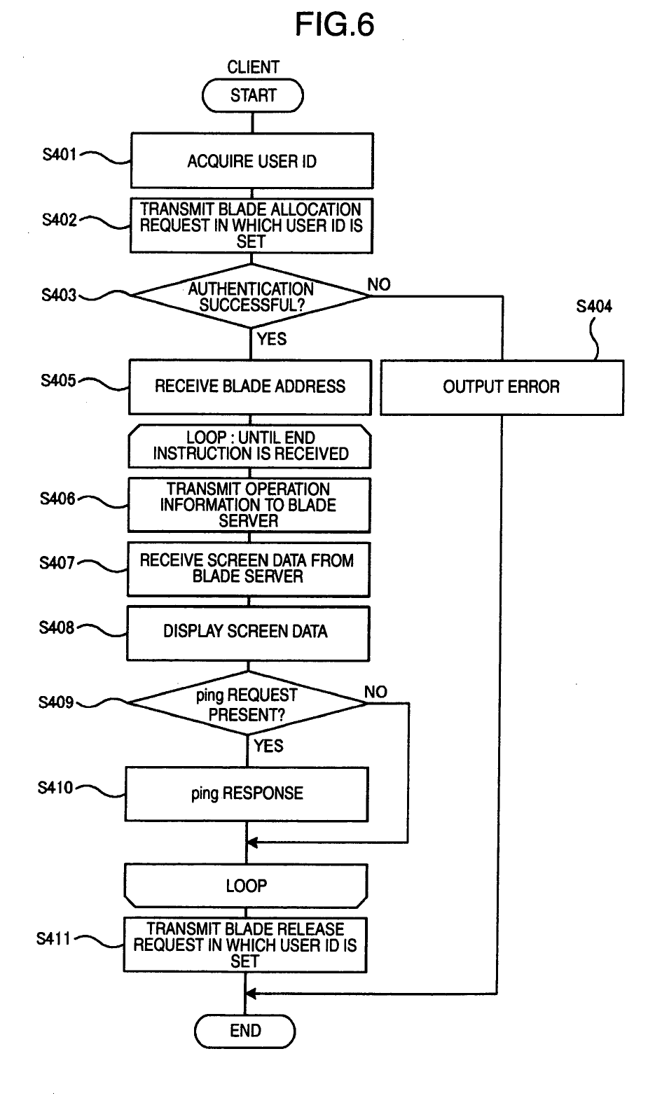

FIG. 6 is a flowchart showing the operations of the client 100.

When the power is turned ON in the client 100, the authentication information acquisition program 106 is executed and the authentication information acquisition unit 131 reads out a user ID from the individual authentication device 120 (S401). The blade allocation request transmission unit 132 transmits the blade allocation request in which the user ID which has been read out is set, to the managing server 300 (S402).

When the user authentication has failed in the managing server 300 (S403: NO), an error is outputted (S404) and the processing is terminated.

When the user authentication is successful (S403: YES), the blade address reception unit 133 receives a blade address transmitted from the managing server 300 and stores it in the memory 101 (S405). The client 100 repeats the following processes until it receives the end instruction such as a log out from the user.

The operation information transmission unit 134 transmits the operation information inputted from the input device such as the keyboard and the mouse to the blade server 200 indicated by the blade address stored in the memory 101 (S406). The screen data reception unit 135 receives the screen data transmitted from the blade server 200 (S407) and outputs the received screen data via a video interface 104 to the display device (S408).

When the ping command response unit 136 has received the ping command from the managing server 300 (S409: YES), it transmits a response to the ping command to the managing server 300 (S410). It should be noted that when the blade server 200 transmits the ping request periodically or when it has not received operation information for a certain time, the ping command response unit 136 may transmit a response to the ping command received from the blade server 200 to the blade server 200.

The client 100 repeats the aforementioned processes until it receives the end instruction from the user and the blade release request transmission unit 137 transmits a blade release request in which a user ID is set to the managing server 300, thereby terminating the process.

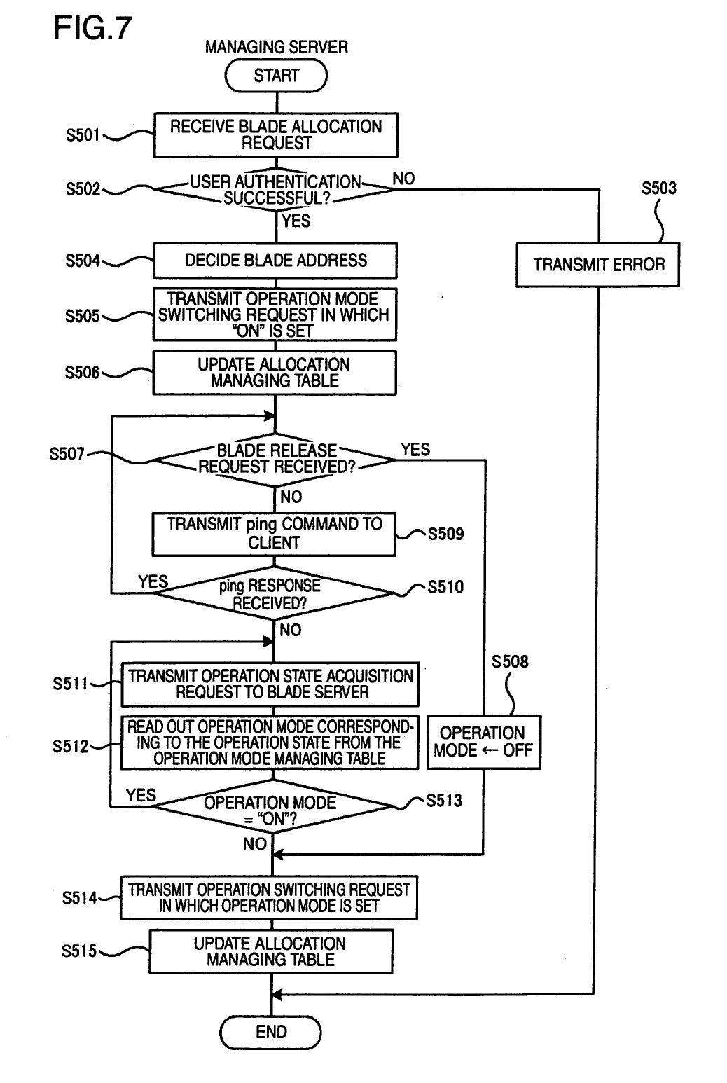

FIG. 7 is a flowchart showing processes of the managing server 300.

When the blade allocation request reception unit 331 receives the blade allocation request from the client 100 (S501), the user authentication unit 332 performs the user authentication process depending on whether the user ID set in the blade allocation request is registered in the allocation managing table 321.

When the authentication fails (S502: NO), an error is transmitted to the client 100 (S503) and the process is terminated.

When the authentication is successful (S502: YES), the blade address allocation unit 333 acquires a blade address corresponding to the user ID from the allocation managing table 321 (S504) and the operation mode switching request transmission unit 337 transmits the operation mode switching request in which “ON” is set to the blade server 200 indicated by the blade address (S505). The blade address allocation unit 333 updates the client address 3213 corresponding to the user ID to an IP address of the client 100 as the transmission source of the blade allocation request in the allocation managing table 321 (S506).

When the blade release request reception unit 338 receives the blade release request from the client 100 (S507: YES), the operation mode decision unit 336 sets the operation mode to “OFF” (S508).

When the blade release request is not received (S507: NO), the client monitor unit 334 transmits the ping command to the client 100 (S509) and waits for a response from the client 100 to the ping command for a predetermined time. When the client monitor unit 334 receives a response from the client 100 (S510: YES), control is passed to step S507.

When the client monitor unit 334 does not receive a response to the ping command from the client 100 within a predetermined time (S510: NO), the program operation state acquisition unit 335 transmits an operation state acquisition request to the blade server 200 (S511) and receives an operation state transmitted from the blade server 200 in accordance with the operation state acquisition request. The operation mode decision unit 336 acquires an operation mode corresponding to the operation state from the operation mode managing table 322 (S512). If the acquired operation mode is “ON” (S513: YES), control is returned to step S511 and the program operation state acquisition unit 335 transmits the operation state acquisition request to the blade server 200.

If the operation mode is other than “ON” (S513: NO), the operation mode switching request transmission unit 337 transmits an operation mode switching request in which the operation mode decided in step S508 or step S512 is set to the blade server 200 (S514) and updates the operation mode 3212 of the allocation managing table 321 corresponding to the user ID to the aforementioned operation mode (S515)

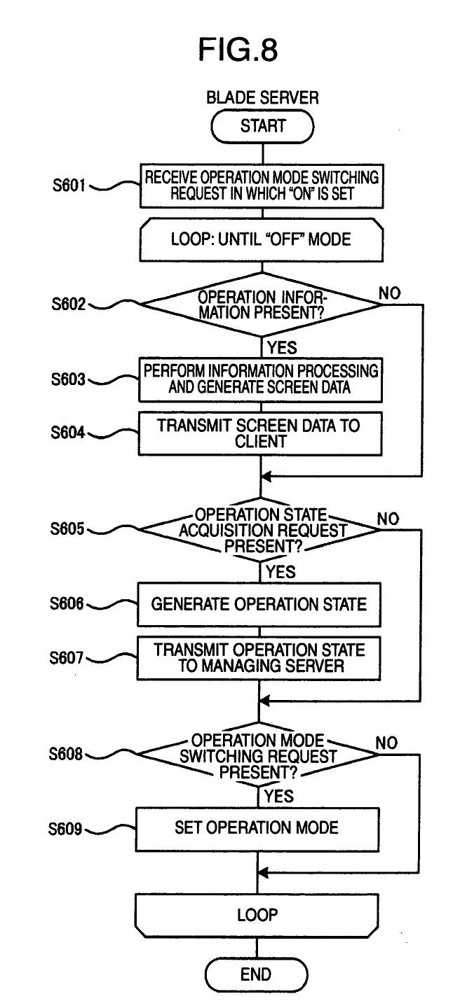

FIG. 8 is a flowchart showing processes of the blade server 200. It should be noted that the processes in FIG. 8 are assumed to be executed when the blade server 200 is in the OFF mode.

When the operation mode switching request reception unit 233 receives the operation mode switching request in which “ON” is set (S601), it repeats the following processes until the operation mode becomes “OFF” mode. The operation mode switching request reception unit 233 is realized as a function of the mBMC 209 and it is assumed that the mBMC 209 can receive power and operate even if the power source 206 of the blade server 200 is OFF.

When the operation information reception unit 235 receives operation information from the client 100 (S602: YES), the information processing unit 236 performs information processing in accordance with the operation information and generates screen data for displaying a screen for outputting the result of the information processing (S603). The screen data transmission unit 237 transmits the generated screen data to the client 100 (S604).

When the operation state acquisition request reception unit 231 receives an operation state acquisition request from the managing server 300 (S605: YES), the operation state transmission unit 232 judges whether the screen saver is being executed in the blade server 200, whether the virus scan program is being executed, whether a file unsaved process is being executed, and generates an operation state containing the aforementioned judgment results (S606). The operation state transmission unit 232 transmits the generated operation state to the managing server 300 (S607).

When the operation mode switching request reception unit 233 receives an operation mode switching request from the managing server 300 (S608: YES), the operation mode switching unit 234 switches the operation mode of the blade server 200 to the operation mode set in the received operation mode switching request (S609). It should be noted that the operation mode setting method may be an ordinary one.

As has been described above, in the information processing system of the present embodiment, the managing server 300 monitors the operation of the client 100 so that when an error has occurred in the client 100, it is possible to switch the operation mode of the blade server 200 allocated for the client 100 to an operation mode which reduces the power consumption of the blade server 200 (hereinafter, referred to as a power saving mode) such as “OFF”, “standby”, and “break”.

Accordingly, in the information processing system of the present embodiment, for example, when an error has occurred in the client 100 or when a user turns OFF the power without performing a termination process, or when a communication failure has occurred in the client 100 side such as when the communication network has failed, it is possible to switch the blade server 200 allocated for the client 100 to a power saving mode. This can suppress unnecessary power consumption of the blade server 200. Moreover, when a failure has occurred in the client 100 side, the blade server 200 can be switched to a power saving mode, which can increase the service life of a hard disk drive, for example.

Moreover, in the information processing system of the present embodiment, when an error has occurred in the client 100 side, the allocation of the blade server 200 can be released and the blade server 200 can be allocated to another normal client 100, thereby effectively operating the blade server 200.

Moreover, when the communication between the client 100 and the blade server 200 is cut off, the information processing in the blade server 200 will not be continued. This reduces the unnecessary use of power and resources of the CPU and the memory. Moreover, it is also possible to reduce the possibility of failure caused by a continuous operation of the blade server 200.

Moreover, in the information processing system of the present embodiment, the managing server 300 can decides the operation mode to be set in accordance with the operation state of the blade server 200. Accordingly, the managing server 300 can terminate the blade server 200 even if no end instruction is received from the client 100.

Moreover, the operation mode based on the operation state of the blade server 200 is set by the operation mode managing table 322. Accordingly, an administrator can flexibly perform tuning of the operation of the blade server 200 by updating the operation mode managing table 322.

Moreover, in the information processing system of the present embodiment, it is possible to set the operation mode of the blade server 200 depending on whether the screen saver is being executed. Accordingly, for example, when the client 100 is set not to return a response to the ping command or when the firewall 162 blocks the ICMP (Internet Control Message Protocol) packet, it is possible to check whether operation information is transmitted to the blade server 200 from the client 100 by checking whether the screen saver is being executed. Even in this case, it is possible to know whether the client 100 has failed. Consequently, the managing server 300 can decide an appropriate operation mode of the blade server 200.

Moreover, in the information processing system of the present embodiment, when the virus scan program is being executed, it is possible to keep the ON mode until execution of the virus scan program is completed without switching to the power saving mode. Accordingly, for the program which is continuously executed for a long time to perform diagnosis of the blade server 200 such as the virus scan program, the execution can be continued in the blade server 200 until the execution is completed even if the client 100 has failed.

Moreover, in the information processing system of the present embodiment, if the file unsaved process is absent, the standby mode is set in and if the file unsaved process is present, the break mode is set in, thereby saving the edition content for the unsaved file stored in the memory in the HDD. Thus, it is possible to recover the edition content even if the power supply to the blade server 200 is unexpectedly cut off.

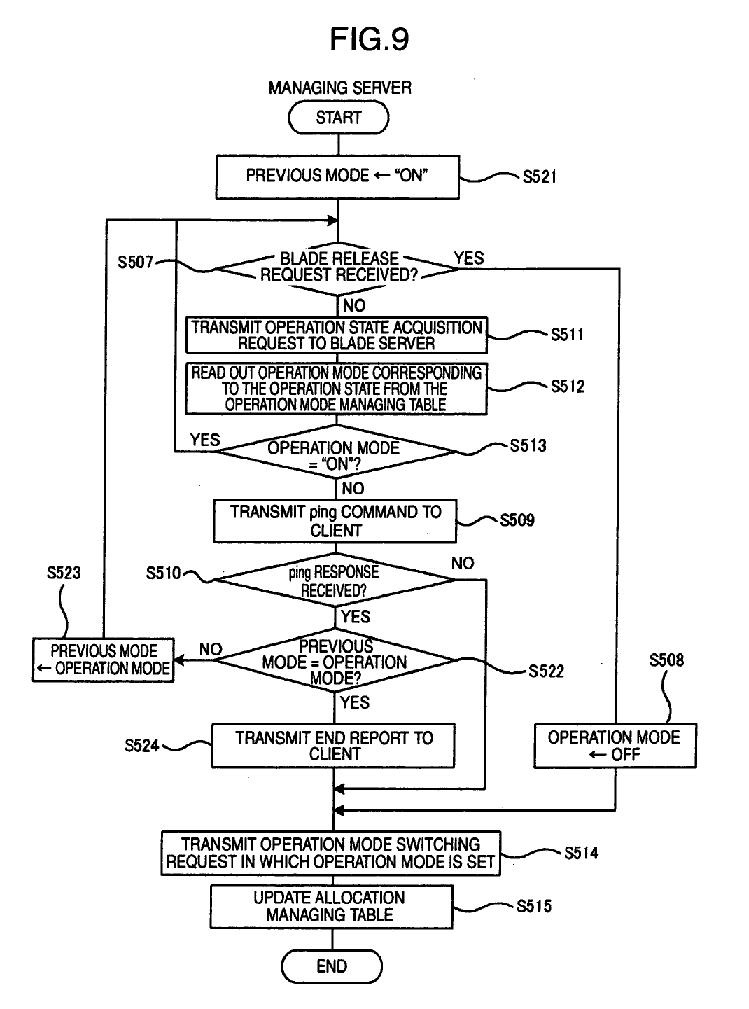

In this embodiment, the managing server 300 periodically transmits the ping command to the client 100 so as to monitor the operation of the client 100. However, it is also possible to check the operation of the client 100 in accordance with the operation state of the blade server 200. FIG. 9 shows the processes performed by the managing server 300 in this case. The processes of FIG. 9 are performed by the managing server 300 instead of the processes of step S507 to step S515 in the aforementioned FIG. 7.

Firstly, the client monitor unit 334 sets a variable previous mode to “ON” (S521). When the blade release request reception unit 338 receives the blade release request from the client 100 (S507: YES), the operation mode decision unit 336 switches the operation mode to “OFF” (S508) and control is passed to step S514.

Next, the program operation state acquisition unit 335 transmits the operation state acquisition request to the blade server 200 (S511) and receives an operation state transmitted from the blade server 200 in response to the operation state acquisition request. The operation mode decision unit 336 acquires an operation mode corresponding to the operation state from the operation mode managing table 322 (S512). If the operation mode acquired by the operation mode decision unit 336 is “ON” (S513: YES), control is returned to step S507.

If the operation mode acquired by the operation mode decision unit 336 is other than “ON” (S513: NO), the client monitor unit 334 transmits the ping command to the client 100 (S509) and waits for a response to the ping command from the client 100 for a predetermined time.

Here, if the client monitor unit 334 receives a response from the client 100 (S510: YES) and if the operation mode acquired by the operation mode decision unit 336 is different from the previous mode (S522: NO), the operation mode is set to the previous mode (S523) and the processes of step S507 and after are repeated.

On the other hand, if the operation mode is identical to the previous mode (S522: YES), the client monitor unit 334 transmits a message (end report) for modifying the operation mode of the blade server 200 to the client 100 (S524).

The operation mode switching request transmission unit 337 transmits an operation mode switching request in which the operation mode decided by the step S508 or the step S512 to the blade server 200 (S514) and updates the operation mode 3212 of the allocation managing table 321 corresponding to the user ID to the aforementioned operation mode (S515).

As has been described above, the managing server 300 can transmit the ping command to the client 100 only if the operation mode corresponding to the operation mode of the blade server 200 is other than “ON”. Accordingly, it is possible to reduce the communication load on the client 100. Moreover, it is also possible to reduce the processing load associated with the ping command of the client 100. Consequently, it is possible to operate the client 100 more effectively. Especially in the case of the thin client configuration, the processing capability of the client 100 is remarkably lower than the processing capability of the blade server 200 and it is possible to improve the processing efficiency as the entire information processing system by reducing the processing load of the client 100 and the communication load.

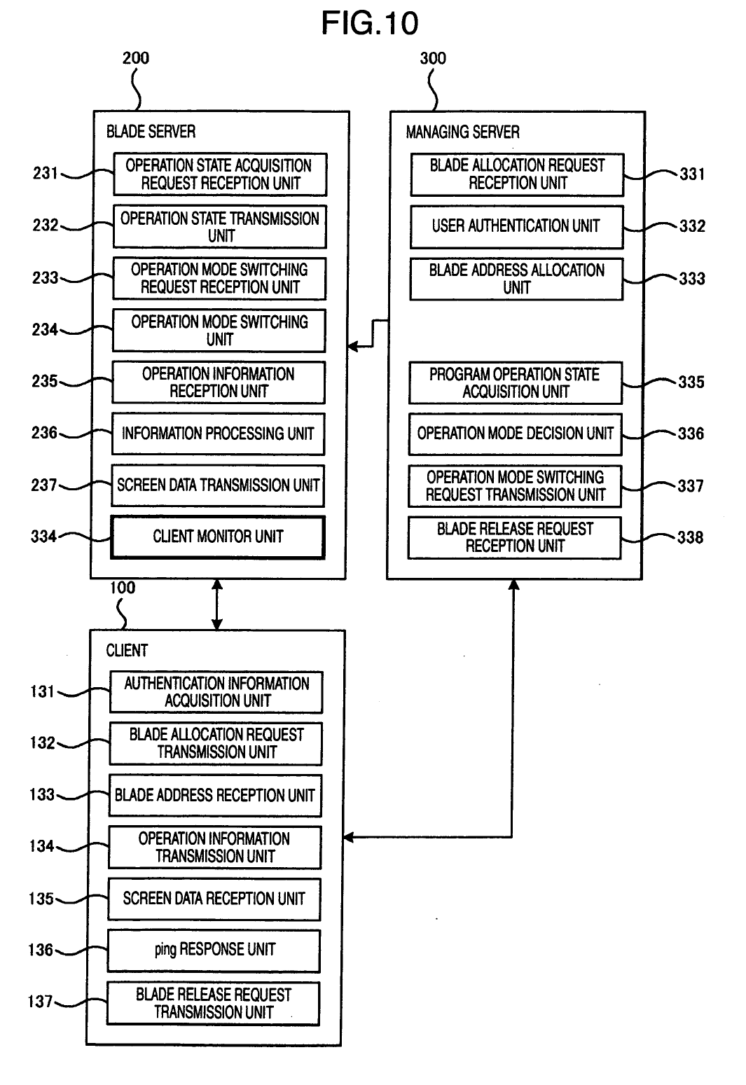

Moreover, in the present embodiment, the operation state of the client 100 is monitored by transmitting the ping command from the managing server 300 to the client 100. However, the blade server 200 can also perform monitoring. The software configuration in this case is shown in FIG. 10. As shown in the figure, the blade server 200 has the client monitor unit 334 of the managing server 300.

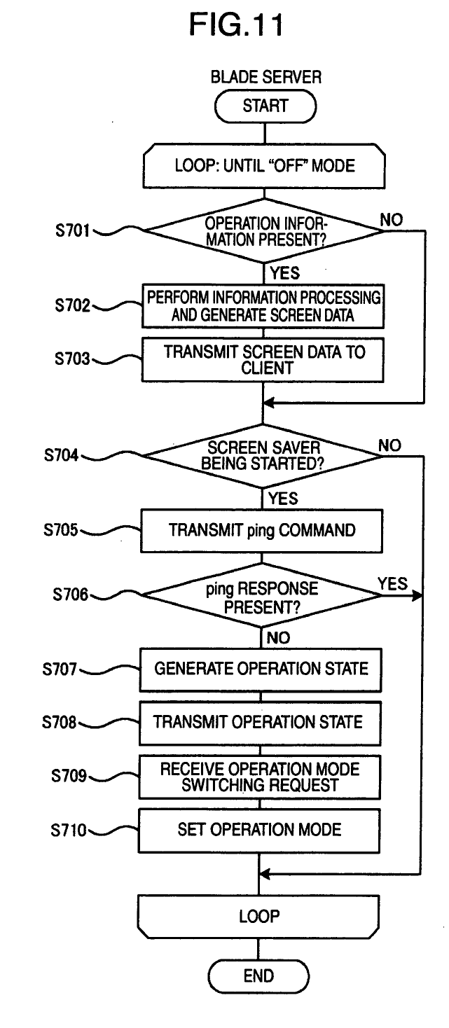

FIG. 11 is a flowchart of the processes performed by the blade server 200 when the blade server 200 monitors the client 100.

In the blade server 200, when the operation information reception unit 235 receives operation information from the client 100 (S701: YES), the information processing unit 236 performs various information processes in accordance with the operation information and generates screen data for indicating the screen for outputting the results of the information processes (S702). The screen data transmission unit 237 transmits the generated screen data to the client 100 (S703).

When the screen saver is executed in the blade server 200 (S704: YES), the client monitor unit 334 transmits the ping command to the client 100 (S705) and checks whether a response to the ping command can be performed from the client 100 within a predetermined time (S706).

When the ping command cannot be received (S706: NO), the operation state transmission unit 232 generates operation state including information on whether the screen saver is being executed, whether the virus scan program is being executed, and whether the file unsaved process is being executed (S707) and transmits the generated operation state to the managing server 300 (S708).

In this case, in the managing server 300, the program operation state acquisition unit 335 receives an operation state from the blade server 200 without transmitting an operation state acquisition request to the blade server 200; the operation mode decision unit 336 reads out the operation mode corresponding to the received operation mode from the operation mode managing table 322; and the operation mode switching request transmission unit 337 transmits an operation mode switching request in which the read-out operation mode is set to the blade server 200.

The operation mode switching request reception unit 233 receives the operation mode switching request (S709) and the operation mode switching unit 234 switches the operation mode of the blade server 200 to the operation mode set in the operation mode switching request (S710).

It should be noted that the client monitor unit 334 may periodically transmit the ping command to the client 100 not depending on whether the screen saver is being executed.

As has been described above, when the blade server 200 monitors the client 100 and an error has occurred in the client 100, it is possible to set the operation mode of the blade server 200 from the managing server 300. Accordingly, it is possible to reduce the monitor load on the client 100 by the managing server 300. Especially when there are a plenty of combinations of the clients 100 and the blade servers 200, each of the blade servers 200 monitors the clients 100 so as to distribute the processing load associated with monitoring of the clients 100. This improves the processing efficiency of the entire information processing system.

It should be noted that the blade server 200 and the managing server 300 may be realized as a single computer. In this case, for example, the blade server 200 includes a video interface for connection with a display device and outputting screen information and a USB interface for connection with a keyboard and a mouse; and the various function units of the managing server 300 are contained in the blade server 200. Moreover, some of the functions of the managing server 300 may be contained in the blade server 200.

Moreover, in this embodiment, the blade server 200 has four operation modes: ON mode, standby mode, break mode, and OFF mode. However, the operation modes are not limited to these. For example, it is possible to add an operation mode to stop only the rotation of the hard disk drive. That is, the operation modes other than the ON mode may be any operation mode where the power consumption of the blade server 200 is reduced as compared to the ON mode of the blade server 200.

Moreover, in this embodiment, it is assumed that a blade server 200 to be used is set in advance for each user ID. However, it is also possible that the managing server 300 dynamically allocates the blade server 200 in accordance with the blade server allocation request.

Moreover, in this embodiment, the operation state of the blade server 200 includes three information pieces: screen saver information, virus scan information, and file unsaved information. However, the operation state may include information indicating other operation states of the blade server 200. For example, the operation state may include a use ratio of the CPU 202 by the blade server 200 per unit time, a use amount of the memory 201, an access amount to the HDD 205 per unit time, and the like.

Moreover, in this embodiment, the operation state of the blade server 200 is acquired by the function unit which is realized when the CPU 202 executes a program stored in the memory 201. However, it may also be realized as the mBMC function. In this case, it is possible to respond a hardware operation state which can be acquired by the mBMC, to the managing server 300. In this case, for example, the operation state may be a processing load of the CPU 202, the surface temperature of the CPU 202, the temperature in the case, the revolution speed of a fan arranged in the case, the number of packets transmitted and received by the NIC 203, and the like.

Moreover, in this embodiment, the managing server 300 registers correspondence between the blade address and the client address in the allocation managing table 321 in accordance with the blade allocation request. However, for example, when the clients 100 are correlated to the blade servers 200 in advance, the managing server 300 may capture packets flowing in the network, statistically process the packet transmission sources and destinations and register the correspondence between the clients 100 and the blade servers 200 in the allocation managing table 321. Moreover, the managing server 300 may inquire the blade server 200 about the IP address of the client 100 with which communication is performed.

Moreover, the blade server 200 may monitor operation of the client 100 and upon detection of a failure, report the failure to the managing server 300. The managing server 300 receives the report from the blade server 200 and transmits the ping command to the client 100 so as to check the operation state of the client 100. Moreover, both of the blade server 200 and the managing server 300 may transmit the ping command to the client 100 so as to monitor the operation of the client 100.

Moreover, in this embodiment, monitoring of the client 100 is performed by checking whether a response to the ping command is present or absent. However, the monitoring may also be performed by transmitting other command to the client 100 and checking whether a response to the command is present or absent. Moreover, it is possible to capture packets flowing in the network and check whether any packet transmitted from the client 100 exists. In this case, by capturing only the packets destined to the blade server 200, it is possible to monitor only the communication between the client 100 and the blade server 200.

The aforementioned embodiment has been given to help understanding of the present invention. The present invention is not to be limited to this embodiment. The present invention may be modified and improved without departing from the spirit of the invention. The present invention includes equivalents of the modified or improved ones.

It should be further understood by those skilled in the art that although the foregoing description has been made on embodiments of the invention, the invention is not limited thereto and various changes and modifications may be made without departing from the spirit of the invention and the scope of the appended claims.

1. An information processing system comprising: a server which receives operation information from a client receiving an operation from a user, executes information processing in accordance with the received operation information, and transmits the information processing result to the client; and a managing device connected to the client and the server;
wherein the managing device includes:
a client monitor unit which monitors whether communication is performed between the client and the server; and
an operation mode switching request transmission unit used when no communication is performed, for transmitting an operation mode switching request to the server so as to instruct it to switch from the current operation mode to a power saving mode consuming less power; and
wherein the server includes:
an operation mode switching request reception unit which receives the operation mode switching request transmitted from the managing device; and
an operation mode switching unit for switching the saver operation mode to the power saving mode in accordance with the operation mode switching request.

2. The information processing system as claimed in claim 1, wherein
the managing device includes a communication amount measuring unit which measures a communication amount between the client and the server; and
the client monitor unit starts the monitoring in accordance with the communication amount.

3. The information processing system as claimed in claim 1, wherein
the managing device includes an operation state acquisition request transmission unit for transmitting an operation state acquisition request for acquiring the operation state of the server to the server;
the server includes an operation state transmission unit for transmitting the operation state of the server to the managing device in response to the operation state acquisition request; and
the client monitoring unit starts the monitoring if the received operation state satisfies a predetermined condition.

4. The information processing system as claimed in claim 3, wherein
the operation state transmission unit transmits as the operation state, at least one of the temperature in the case of the server, the surface temperature of the CPU of the server, the processing load of the CPU, and the revolution speed of the fan arranged in the case, to the managing device.

5. The information processing system as claimed in claim 3, wherein
the operation state transmission unit transmits information indicating whether the program to be executed in the server is being executed as the operation state to the managing device if the operation information is not received for a predetermined time.

6. The information processing system as claimed in claim 3, wherein the operation state transmission unit transmits as the operation state, information indicating whether a process for managing a file identifier is being edited and not yet stored in the managing device.

7. The information processing system as claimed in claim 1, wherein
the server includes the client monitor unit;
the server includes an operation state transmission unit for transmitting the operation state of the server to the managing device when no communication is performed between the client and the server;
the managing device includes:
an operation state reception unit for receiving the operation state transmitted from the server; and
a condition storage unit for storing mode information indicating the power saving mode while correlating it to a preset condition;
the operation mode switching request transmission unit reads out the mode information corresponding to the condition satisfied by the operation state among the condition from the condition storage unit, sets the mode information which has been read out, into the operation mode switching request, and transmits the request to the server; and
the operation mode switching unit switches the operation mode of the server to the power saving mode indicated by the mode information set in the operation mode switching request.

8. An information processing method used in an information processing system comprising: a server which receives operation information from a client receiving an operation from a user, executes information processing in accordance with the received operation information, and transmits the information processing result to the client; and a managing device connected to the client and the server;
wherein the managing device monitors whether communication is performed between the client and the server;
the managing device transmits an operation mode switching request to the server so as to instruct it to switch from the current operation mode to a power saving mode consuming less power if no communication is performed;
the server receives the operation mode switching request transmitted from the managing device; and
the server switches the saver operation mode to the power saving mode in accordance with the operation mode switching request.

9. The information processing method as claimed in claim 8, wherein
the managing device measures a communication amount between the client and the server; and
the managing server starts the monitoring in accordance with the communication amount.

10. The information processing method as claimed in claim 8, wherein
the managing device transmits an operation state acquisition request for acquiring the operation state of the server to the server;
the server transmits the operation state of the server to the managing device in response to the operation state acquisition request;
the managing device receives the operation state transmitted in response to the operation state acquisition request; and
the managing device starts the monitoring if the received operation state satisfies a predetermined condition.

11. The information processing method as claimed in claim 10, wherein
the server transmits as the operation state, at least one of the temperature in the case of the server, the surface temperature of the CPU of the server, the processing load of the CPU, and the rpm of the fan arranged in the case to the managing device.

12. The information processing system as claimed in claim 10, wherein
the server transmits information indicating whether the program to be executed in the server is being executed as the operation state to the managing device if the operation information is not received for a predetermined time.

13. The information processing method as claimed in claim 10, wherein
the server transmits as the operation state, information indicating whether a process for managing a file identifier being edited and not yet stored to the managing device.

14. The information processing method as claimed in claim 8, wherein
the server monitors whether communication is performed between the client and the server;
the server transmits the operation state of the server to the managing device if no communication is performed between the client and the server;
the managing device receives the operation state transmitted from the server;
the managing device stores mode information indicating the power saving mode while correlating it to a preset condition;
the managing device reads out the mode information corresponding to the condition satisfied by the operation state among the condition from the condition storage unit, sets the mode information which has been read out, into the operation mode switching request, and transmits the request to the server; and
the server switches the operation mode of the server to the power saving mode indicated by the mode information set in the operation mode switching request.

15. A program for causing an information processing device which is communicably connected to a client for receiving an operation from a user and to a server for receiving the operation information from the client, performing an information process in accordance with the received operation information, and transmitting the result of the information process to the client, to execute:
a step of monitoring whether communication is performed between the client and the server; and
a step of transmitting an operation mode switching request to switch the operation mode of the server to a power saving mode requiring less power consumption than the current operation mode if no communication is performed.

16. The program as claimed in claim 15, further causing the information processing device to execute:
a step of transmitting an operation state acquisition request for acquiring an operation state of the server;
a step of receiving the operation state transmitted in response to the operation state acquisition request; and
a step of starting the monitoring if the received operation state satisfies a preset condition.
